(19) United States
(12) Patent Application Publication
(10) Pub. No.: US 2012/0251700 A1
(43) Pub. Date: Oct. 4, 2012

(54) FOOD ADDITIVE

(76) Inventors: Deanna L. Hofing, Coatesville, IN (US); Rolf Haeussler, Oestrich-Winkel (DE)

(21) Appl. No.: 13/418,976

(22) Filed: Mar. 13, 2012

Related U.S. Application Data
(63) Continuation-in-part of application No. 13/230,092, filed on Sep. 12, 2011.
(60) Provisional application No. 61/382,175, filed on Sep. 13, 2010.

(51) Int. Cl. A23L 3/3463

(52) U.S. Cl. 426/542; 426/541; 426/442

(57) ABSTRACT

The present invention relates to a food additive, and more particularly to a food additive that provides antimicrobial properties, and extends shelf life while maintaining the flavor profile of the foodstuff. The food additive may include 85 to 95 percent by weight sodium or potassium salt, 1 to 10 percent by weight of at least one compound having antioxidant properties, 0.1 to 10 percent by weight of at least one mustard family based compound, and 0 to 1 percent by weight of at least one tea based compound.

### CROSS REFERENCE TO RELATED APPLICATIONS

This application is a continuation-in-part of U.S. application Ser. No. 13/230,092, filed Sep. 12, 2011, currently pending, which claims priority to U.S. Provisional Application Ser. No. 61/382,175, filed Sep. 13, 2010, the disclosures of which are incorporated herein by reference in their entirety.

### FIELD AND BACKGROUND OF THE INVENTION

The present invention relates to a food additive, and more particularly to a food additive that provides antimicrobial properties, and extends shelf life while maintaining the flavor profile of the foodstuff.

During the processing, preparation, packaging, and use of a foodstuff, the foodstuff is susceptible to microorganisms which may make the foodstuff unsuitable for consumption. Exemplary foodstuffs include meat, poultry, fish and shellfish, cheese, fruits and vegetables, and prepared foods. Being unsuitable for consumption, ranges from the perception of lower quality to food-borne illnesses and possibly death. Exemplary problematic microorganisms include Listeria monocytogenes, Salmonella, E. Coli, staphylococcus aureas, and clostridium perfringens.

### SUMMARY OF THE INVENTION

To this end, it is desirable to provide a food additive that when added to a foodstuff has antimicrobial and antioxidant properties and also extends shelf life, and has a perception of either maintaining or improving the flavor of the foodstuff. Additionally, the food additive includes ingredients that are GRAS grade materials.

In one embodiment, the food additive comprises 85 to 95 percent by weight sodium or potassium salt, 1 to 10 percent by weight of at least one compound having antioxidant properties, 0.1 to 10 percent by weight of at least one mustard family based compound, and 0.1 to 1 percent by weight of at least one tea based compound.

In another embodiment, the food additive comprises 85 to 95 percent by weight sodium or potassium salt, 1 to 10 percent by weight of at least one compound having antioxidant properties, 1 to 10 percent by weight of a clove and/or cinnamon extract and limonene oil and/or eucalyptus oil, and 0.1 to 1 percent by weight of at least one tea based compound.

In another embodiment, the food additive comprises 85 to 95 percent by weight sodium or potassium salt, 1 to 10 percent by weight of at least one compound having antioxidant properties based on a herbal or fruit component such as a herbal or fruit extract, 1 to 10 percent by weight of an Euginol oil and/or limonene oil and/or eucalyptus oil and/or a mushroom-based compound.

In another embodiment, the food additive comprises 0.1 to 50 percent by weight of at least one compound having antioxidant properties based on a herbal or fruit component such as a herbal or fruit extract, 0 to 50 percent by weight of an Euginol oil and/or limonene oil and/or eucalyptus oil, and/or a mushroom-based compound, and 0 to 50 percent of a source of acetic acid. A salt may also be optionally included.

### BRIEF DESCRIPTION OF THE DRAWINGS

FIG. 1 is a Log CFU/g versus time graph for Aerobic Plate Count for Examples 1-8.

FIG. 2 is a Log CFU/g versus time graph for Aerobic Plate Count for Examples 9-15.

FIG. 3 is a Log CFU/g versus time graph for Coliform for Examples 1-8.

FIG. 4 is a Log CFU/g versus time graph for Coliform for Examples 9-15.

FIG. 5 is a Log CFU/g versus time graph for Yeast for Examples 1-8.

FIG. 6 is a Log CFU/g versus time graph for Yeast for Examples 9-15.

FIG. 7 is a Log CFU/g versus time graph for Mold for Examples 1-8.

FIG. 8 is a Log CFU/g versus time graph for Mold for Examples 9-15.

FIG. 9 is a Log Bacteria/g versus time graph for Lactic Acid Bacteria for Examples 1-8.

FIG. 10 is a Log Bacteria/g versus time graph for Lactic Acid Bacteria for Examples 9-15.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In case of a conflict in terminology, the present specification is controlling.

The present invention provides a food additive for application to a foodstuff to limit microbial activity, import antioxidant properties, and improve shelf life without an adverse affect on the flavor of the foodstuff (i.e., the organoleptic properties of the foodstuff are maintained or improved). The term “foodstuff” is intended to mean a substance which is suitable for human or animal consumption, and includes dairy products (e.g., cheese), animal foods (e.g., dog and cat food), snack foods (e.g., pretzels, chips, crackers), sauces and gravies, soups, casseroles, juices (e.g., fruits and vegetables), prepared meat and meat spreads, cereals, margarine, salad dressings, condiments (e.g., ketchup and mustard), meat, fish and shellfish, and poultry.

The food additive comprises 85 to 95 percent by weight sodium or potassium salt, 1 to 10 percent by weight of at least one compound having antioxidant properties, 0.1 to 10 percent by weight of at least one mustard family based compound, and 0.1 to 1 percent by weight of at least one tea based compound. The compound having antioxidant properties may be a herb or fruit component having such properties such as a herbal or fruit extract. Alternatively, the food additive comprises 85 to 95 percent by weight sodium or potassium salt, 1 to 10 percent by weight of at least one herbal or fruit extract having antioxidant properties, 0 to 10 percent by weight of an Euginol oil and limonene oil and/or eucalyptus oil, and/or a mushroom-based compound, and 0 to 1 percent by weight of at least one tea based compound.

Suitable sodium and potassium salts include sodium chloride, potassium chloride, sea salt, potassium citrate and sodium citrate.

Exemplary compounds having antioxidant properties derived from herbal components include extracts and oils derived from rosemary, bilberry, ginkgo biloba, pine bark, olive leaf, turmeric, oregano, coriander, clove, cinnamon, and blends thereof. Exemplary compounds having antioxidant properties derived from fruit components include extracts and oils derived from pomegranate, grape, grapeseed, acai, tart cherry, grapefruit seed, cranberry, blueberry, and strawberry.

Suitable mustard based compounds include oils and extracts derived from mustard plants, broccoli, Brussels sprouts, cabbage, cauliflower, kale, radishes, and cresses.

Suitable tea based compounds include green tea extract, black tea extract and oolong tea extract, and blends thereof.

In another embodiment, 1 to 10 percent by weight of Euginol oil (e.g., clove and/or cinnamon extract) and/or a source of citrus (e.g., limonene oil) and/or eucalyptol oil, and/or a mushroom-based compound may be included or used in place of the mustard family based compound and/or the tea extract.

In one embodiment, the food additive comprises 85 to 95 percent by weight sodium or potassium salt, 1 to 10 percent by weight rosemary extract, 1 to 5 percent by weight mustard oil, and 0.1 to 1 percent by weight green tea extract.

In another embodiment, the food additive comprises 0 to 50 percent by weight of at least one compound having antioxidant properties based on a herbal or fruit component such as a herbal or fruit extract, 0 to 50 percent by weight of an Euginol oil and/or limonene oil and/or eucalyptus oil, and/or a mushroom-based compound, and 0 to 50 percent of a source of acetic acid. A salt may also be optionally included.

The food additive may include a functional additive such as sources of acetic acid (e.g., liquid or dry vinegar), dust control additives (e.g., vegetable oil), emulsifiers, preservatives, antioxidants, colorants, antimicrobials, flavorings, and anti-caking agent. Preferably these additives are on the GRAS list issued by the FDA.

The food additive is added or applied to the foodstuff in a form and method known to those skilled in the art. For example, the additive can be in the form of a powder, granular blend, or a liquid, and can be applied to or mixed with the foodstuff using marination, kneading, blending, tumbling, spraying, massaging, injecting, mixing and the like.

The present invention will be further illustrated by the following non-limiting examples.

### EXAMPLES

Various compositions of the invention were tested to determine the affect on shelf life in raw marinated chicken. Chicken breast was acquired from the University of Wisconsin, Madison and was seven to ten days old at the time of testing. Each chicken breast was cut in half to expose more surface area and provide more samples for testing shelf life. All green weights were recorded prior to enhancement; with the goal being a constant 4.0 lbs of meat and 0.60 lbs of marinade. Goal was for a 15 percent pick up. Chicken and marinade treatment were tumbled for 10-12 minutes at 25-27 rpm in a vacuum tumbler. Meat weights were then recorded after tumbling to determine pick up percentage of antimicrobial based marinade. Product was then placed in the raw meat cooler to rest overnight prior to taste testing and for shelf life study. To ensure minimal cross contamination knives and table tops were sprayed with a food grade sanitizing spray. Tumbling vessels were rinsed thoroughly between treatments.

The control composition was 98.65% water, 1% salt, and 0.35% phosphate.

The samples were transported to the testing facility under refrigerated conditions and the temperature maintained at 38°to 40° F. The samples were evaluated in duplicate on days 1, 7, 14, and 20. The evaluation comprised: 1) aerobic plate count; 2) coliform; 3) lactic acid bacteria; and 4) yeast and 5) mold.

At each test point one raw chicken sample of each variable was aseptically opened, two twenty-five gram test aliquots were weighed, sterile phosphate buffer was added, samples were stomached for two minutes, serially diluted and plated using Plate Count Agar (PCA) for aerobic plate count, Violet Red Bile Agar (VRBA) for coliform, Lactobacilli deMan, Rogosa, & Sharpe (MRS) Agar for lactic acid bacteria and Potato Dextrose Agar (PDA) for yeast and for mold. PCA plates were incubated at 25° C. for 72 hours, VRBA plates were incubated at 35° C. for 24 hours, MRS agar and PDA plates were incubated at 25° C. for 5 days. Colonies were counted and recorded.

All examples provided in water with percentages by weight in water.

### EXAMPLES

### Example 1

1% salt, 0.25% limonene, and 0.75% vinegar powder.

### Example 2

1% salt, 0.12% limonene, 0.86% vinegar powder, 0.015% rosemary extract/pomegranate extract.

### Example 3

1.24% salt, 0.04% rosemary extract, and 0.04% green tea extract.

### Example 4

1.08% salt, 0.205% limonene, 0.0125% rosemary extract, and 0.0125% green tea extract.

### Example 5

1.24% salt, 0.04% rosemary extract, 0.04% green tea extract, and 0.20% vinegar powder.

### Example 6

1.08% salt, 0.205% limonene, 0.0141% rosemary extract, 0.0141% green tea extract, and 0.121% vinegar powder.

### Example 7

1% salt, 0.25% limonene, 0.75% vinegar powder, and 0.05% Euginol oil.

### Example 8

1% salt, 0.31% limonene, and 0.68% vinegar powder.

### Example 9

1.45% salt, 0.075% rosemary extract, and 0.075% green tea extract.

### Example 10

1.60% salt, 0.10% rosemary extract, and 0.10% green tea extract.

### Example 11

1% salt, 0.87% Mizkan vinegar powder, and 0.13% natural Mushroom compound.

### Example 12

1% salt, 0.56% Mizkan vinegar powder, 0.51% Naturex vinegar powder, and 0.11% natural Mushroom compound.

### Example 13

1.13% salt, 0.56% vinegar powder, 0.022% rosemary extract, and 0.022% green tea extract.

### Example 14

1% salt, 0.68% Mizkan vinegar powder, 0.21% Naturex vinegar powder, and 0.11% natural Mushroom compound.

### Example 15

1% salt, 0.65% Mizkan vinegar powder, and 0.10% natural Mushroom compound.

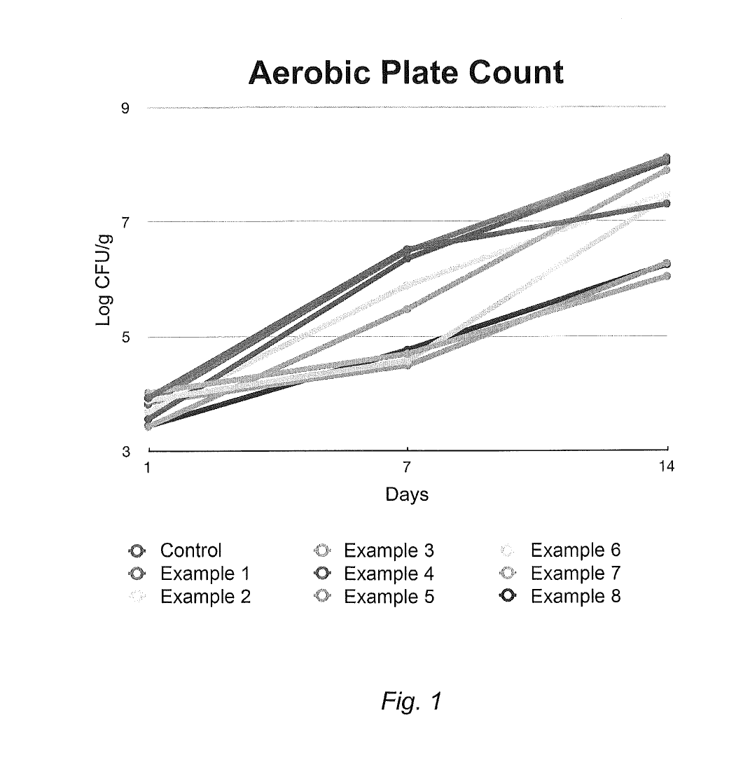

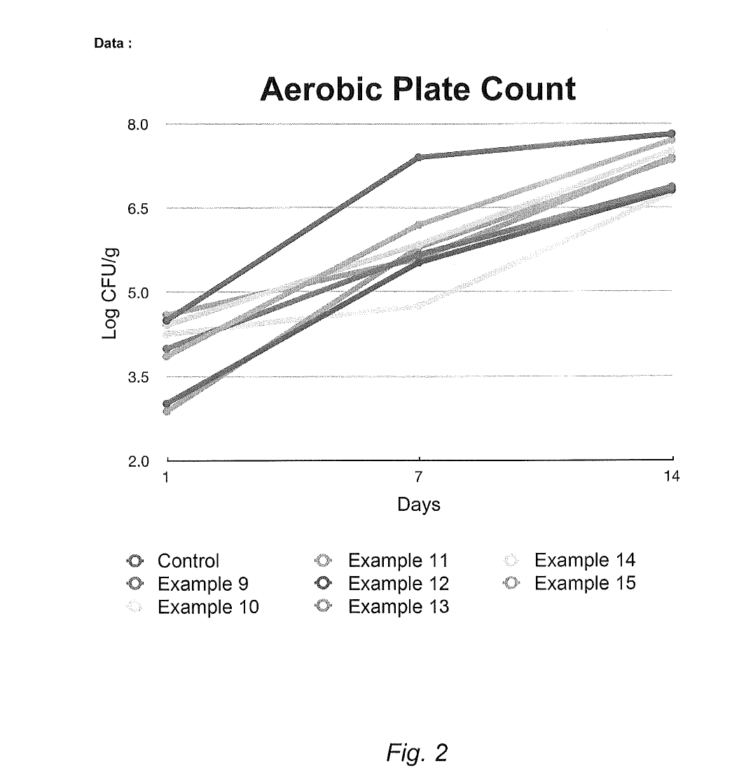

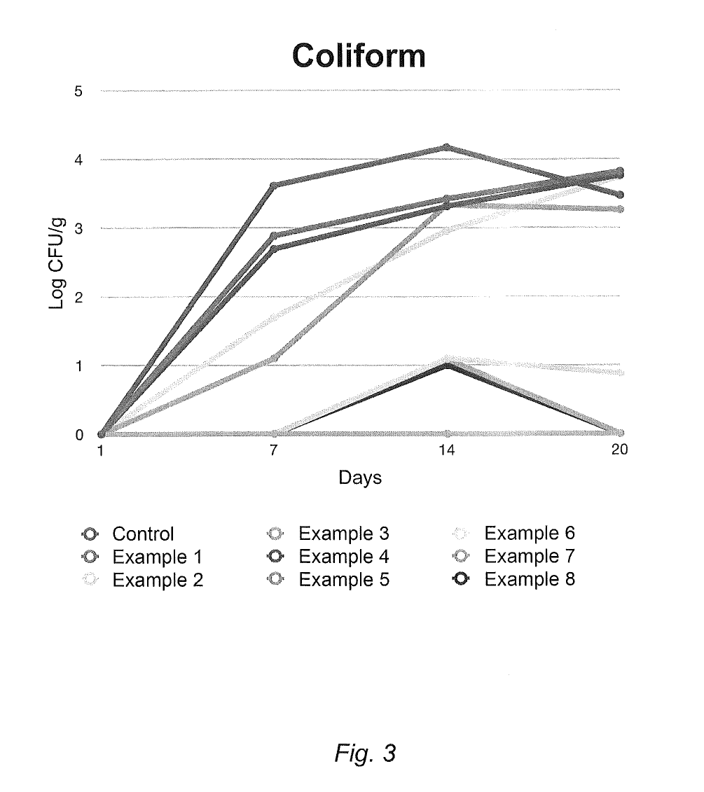

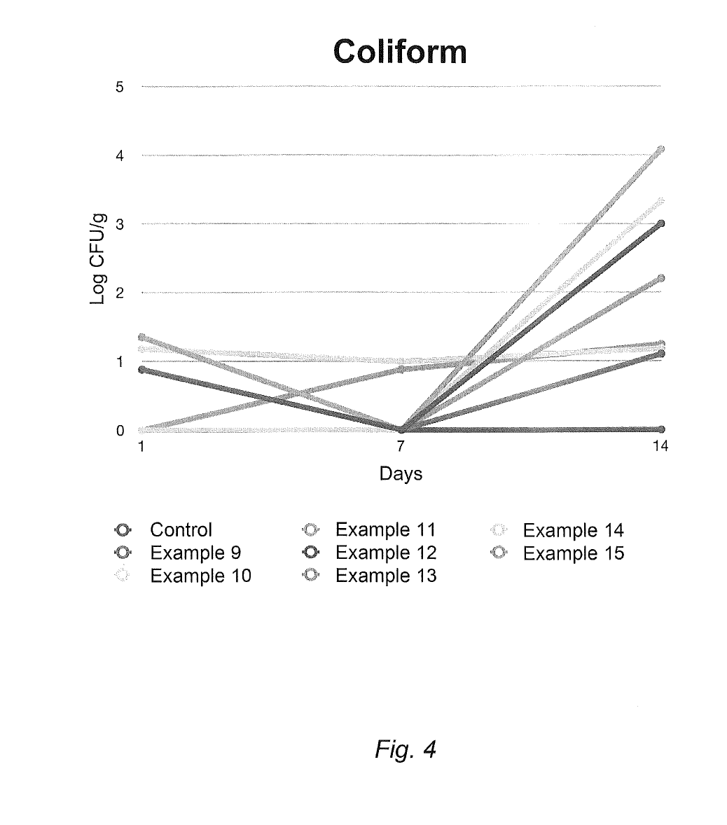

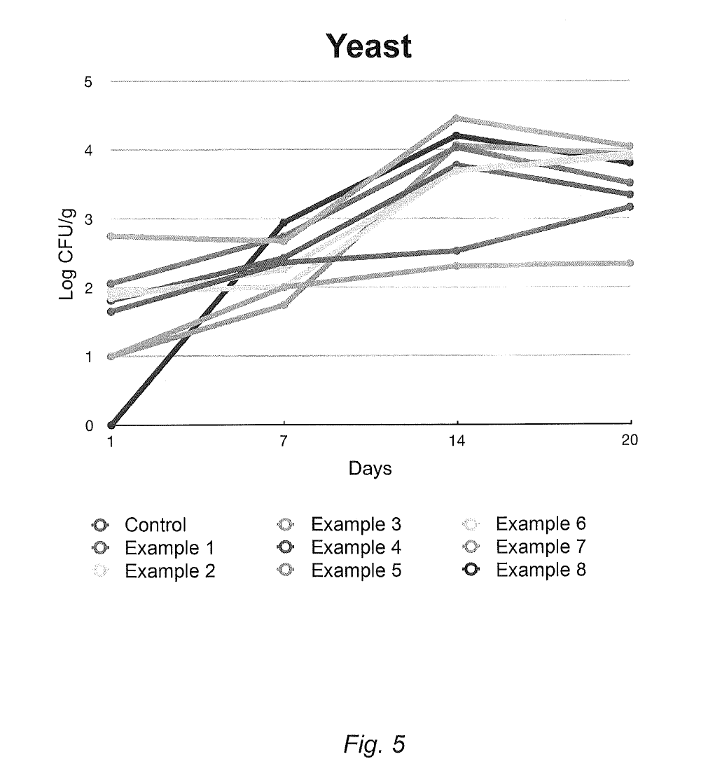

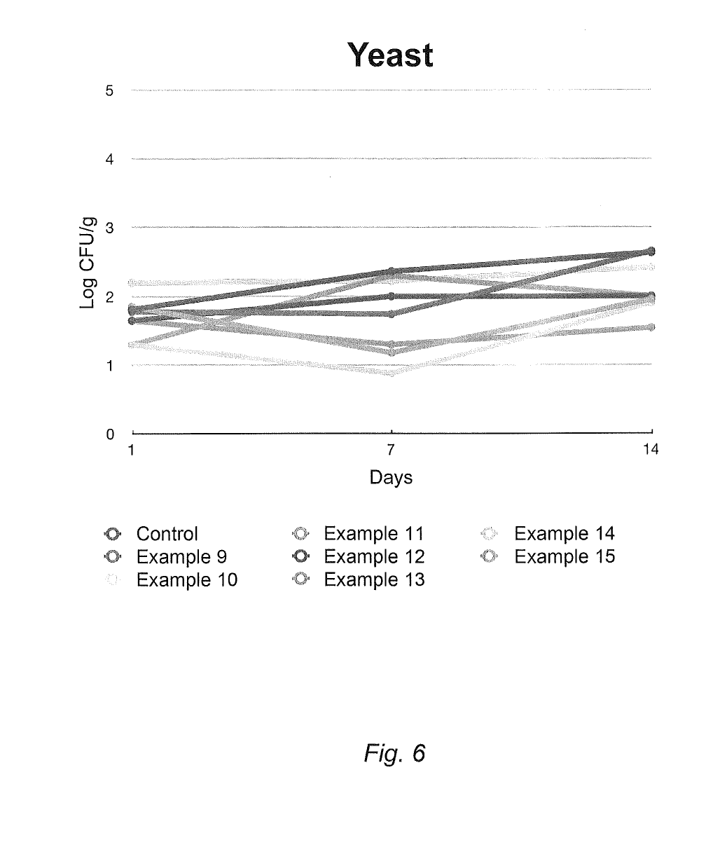

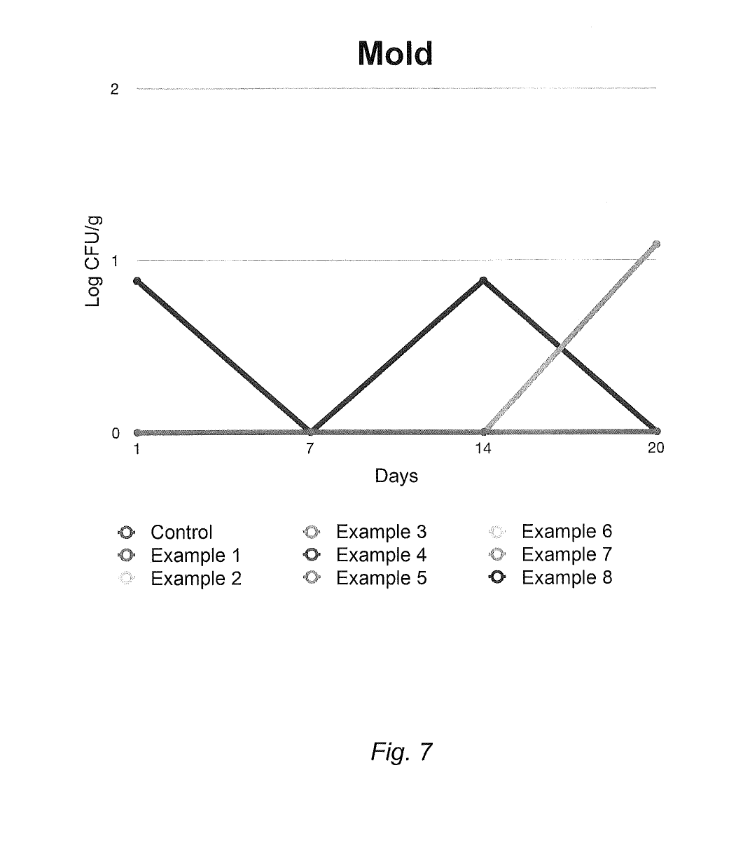

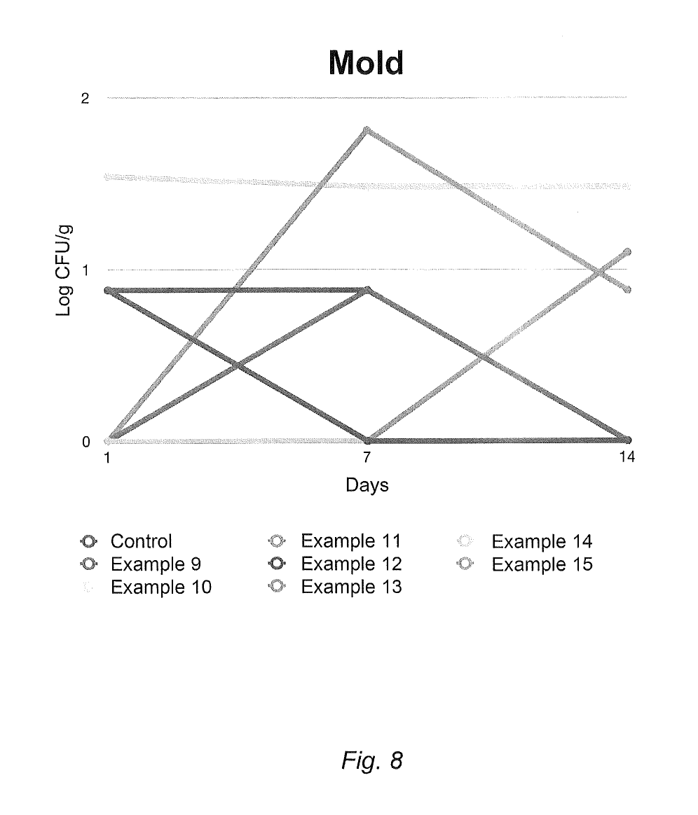

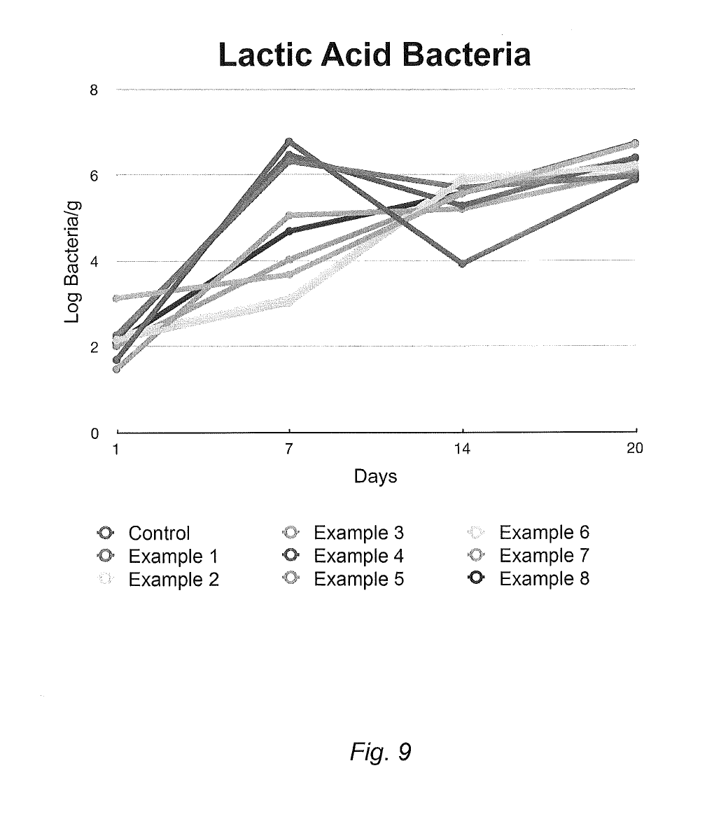

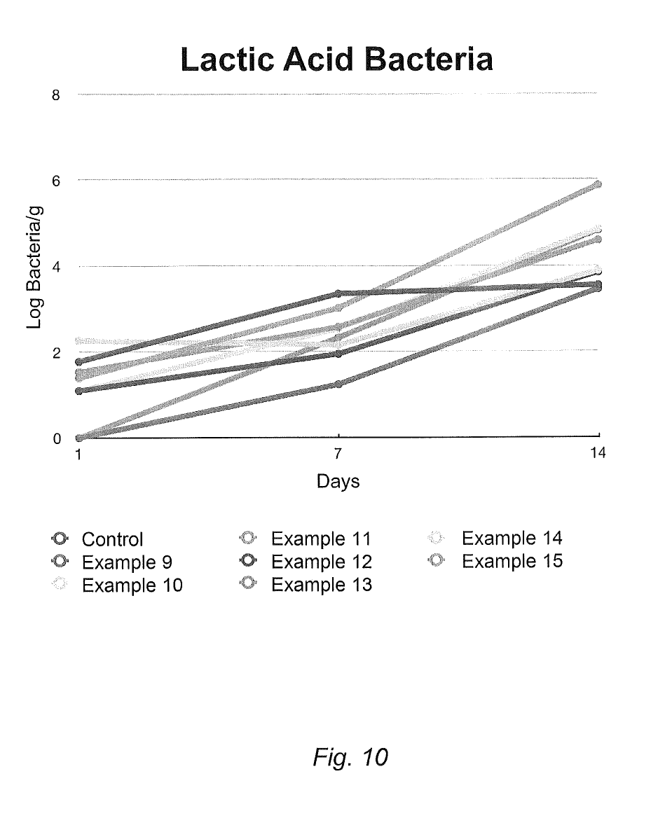

The results for aerobic plate count, coliform, yeast, mold, and lactic acid bacteria are shown in FIGS. 1-10. The results show that various compositions of the invention inhibit the growth of various antimicrobes and can lead to extended shelf life.

Having thus described certain embodiments of the present invention, it is to be understood that the invention defined by the appended claims is not to be limited by particular details set forth in the above description including the examples as many apparent variations thereof are possible without departing from the spirit or scope thereof as hereinafter claimed.

That which is claimed:

1. A food additive comprising
(a) 85 to 95 percent by weight sodium or potassium salt;
(b) 1 to 10 percent by weight of at least one compound having antioxidant properties; and
(c) 0.1 to 10 percent by weight of at least one of a mustard family based compound, Euginol oil, limonene oil, and/or eucalyptol oil, and/or a mushroom-based compound, and a tea based compound.

2. The food additive according to claim 1, wherein the sodium salt is sodium chloride

3. The food additive according to claim 1, wherein the compound having antioxidant properties is derived from a herbal component and is at least one extract or oil derived from rosemary, oregano, bilberry, ginkgo biloba, pine bark, olive leaf, turmeric, coriander, clove, cinnamon, and blends thereof.

4. The food additive according to claim 3, wherein the mustard family based compound is mustard oil.

5. The food additive according to claim 1, wherein the tea based compound is selected from the group consisting of green tea extract, black tea extract and oolong tea extract, and blends thereof.

6. The food additive according to claim 1, further comprising an additional additive.

7. The food additive according to claim 6, wherein the additional additive is a source of acetic acid.

8. The food additive according to claim 7, wherein the source of acetic acid is dry or liquid vinegar.

9. The food additive according to claim 1, further comprising a dust control compound.

10. The food additive according to claim 9, wherein the dust control compound is vegetable oil.

11. A composition for reducing the amount of sodium or potassium salt in a food additive while maintaining the desired flavoring, the composition comprising:
(a) 1 to 90 percent by weight of at least compound having antioxidant properties derived from a herbal or fruit component having antioxidant properties;
(b) 1 to 90 percent by weight of mustard family based compound and/or Euginol oil and/or limonene oil and/or eucalyptol oil, and/or a mushroom-based compound;
(c) 0 to 1 percent by weight of at least one tea based compound; and
(d) 0 to 50 percent by weight of a course of acetic acid.

12. The composition according to claim 11, wherein the compound having antioxidant properties derived from a herbal or fruit component having antioxidant properties is derived from a herbal component and is an extract or oil derived from rosemary, oregano, bilberry, ginkgo biloba, pine bark, olive leaf, turmeric, coriander, clove, cinnamon, and blends thereof.

13. The composition according to claim 11, wherein the mustard family based compound is mustard oil.

14. The composition according to claim 11, wherein the tea based compound is selected from the group consisting of green tea extract, black tea extract and oolong tea extract, and blends thereof.

15. The composition according to claim 11, further comprising an additional additive.

16. The composition according to claim 11, comprising 0.1 to 1 percent of a tea-based compound.

17. The composition according to claim 11, further comprising a potassium or sodium salt.

18. The composition according to claim 11, wherein the source of acetic acid is dry vinegar.

19. The composition according to claim 11, further comprising a dust control compound.

20. The composition according to claim 19, wherein the dust control compound is vegetable oil.

21. A food additive comprising:
(a) 85 to 95 percent by weight sodium or potassium salt;
(b) 1 to 10 percent by weight rosemary extract;
(c) 1 to 5 percent by weight mustard oil; and
(d) 0.1 to 1 percent by weight green tea extract.

22. The foodstuff according to claim 21, wherein the sodium salt is sodium chloride.

23. The food additive according to claim 21, further comprising an additive.

24. The food additive according to claim 23, wherein the additive is a source of acetic acid.

25. The food additive according to claim 24, wherein the source of acetic acid is dry vinegar.

26. The food additive according to claim 21, further comprising a dust control compound.

27. The food additive according to claim 26, wherein the dust control compound is vegetable oil.

28. A method of treating a foodstuff to provide improved organoleptic properties and antioxidant properties, the method comprising applying the food additive of claim 1 to a foodstuff.

29. The method of claim 28, whereby the foodstuff is selected from the group consisting of dairy products, animal foods, snack foods, sauces and gravies, soups, casseroles, juices, prepared meat and meat spreads, cereals, margarine, salad dressings, condiments, meat, fish and shellfish, and poultry.

30. A method of treating a foodstuff to provide improved organoleptic properties and antioxidant properties, the method comprising applying the food additive of claim 21 to a foodstuff

31. The method of claim 30, whereby the foodstuff is selected from the group consisting of dairy products, animal foods, snack foods, sauces and gravies, soups, casseroles, juices, prepared meat and meat spreads, cereals, margarine, salad dressings, condiments, meat, fish and shellfish, and poultry.
